(19) United States
(12) Patent Application Publication
(10) Pub. No.: US 2026/0023874 A1
(43) Pub. Date: Jan. 22, 2026

(54) SYSTEM AND METHOD FOR ENHANCED SUMMARY STATISTIC PRIVACY FOR DATA SHARING

(71) Applicant: JPMorgan Chase Bank, N.A., New York, NY (US)

(72) Inventors: Shuaiqi WANG, Pittsburgh, PA (US); Rongzhe WEI, Atlanta, GA (US); Mohsen GHASSEMI, Jersey City, NJ (US); Eleonora KREACIC, London (GB); Vamsi Krishna POTLURU, New York, NY (US)

(73) Assignee: JPMorgan Chase Bank, N.A., New York, NY (US)

(21) Appl. No.: 18/777,201

(22) Filed: Jul. 18, 2024

(51) Int. Cl. G06F 21/62

(52) U.S. Cl. CPC G06F 21/6245

(57) ABSTRACT

Various methods and processes, apparatuses or systems, and media for protecting confidential aggregate dataset information when sharing data are disclosed. A receiver receives confidential dataset from a data owner via a communication interface, the confidential dataset including a multi-dimensional privacy data, and being generated from an original distribution of dataset as released distribution dataset. A processor, operatively connected to the receiver, defines a privacy metric as a probability of an attacker guessing the multi-dimensional privacy data by applying a first data processing algorithm onto the confidential dataset; defines a distortion metric of a data release mechanism as worst-case distance between the original distribution dataset and the released distribution dataset by applying a second data processing algorithm; and implements the data release mechanism that minimizes the distortion metric subject to a constraint on the privacy metric for protecting the confidential aggregate dataset information when sharing data.

### TECHNICAL FIELD

This disclosure generally relates to data processing, and, more particularly, to methods and apparatuses for implementing a platform, language, cloud, and database agnostic data sharing module configured for analyzing the risks of compromising confidential dataset-level information when sharing data, and implementing “quantization-based” methods that provide provable privacy guarantees.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Data sharing may be playing a more and more important role in nowadays research and applications. However, the summary statistics of the shared data may contain sensitive information that the data owners want to hide. Nevertheless, there are few works focusing on protecting the summary statistics properties of the released datasets.

Conventional tools may provide a privacy framework that may define, analyze, and protect the summary statistics privacy concerns. However, the conventional tools only consider the scenario where there is only one summary statistics secret that the data owner intend to protect. However, in practice, more than one summary statistics property of the shared data could be regarded as the business secrets. Therefore, it may prove to be extremely important to generalize the single secret summary statistics privacy framework to ensure it can cover the multiple secrets scenario.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic data sharing module configured for analyzing the risks of compromising confidential dataset-level information when sharing data, and implementing “quantization-based” methods that provide provable privacy guarantees, thereby protecting confidential aggregate dataset information when sharing data, but the disclosure is not limited thereto.

According to exemplary embodiments, a method for protecting confidential aggregate dataset information when sharing data by utilizing one or more processors along with allocated memory is disclosed. The method may include: receiving confidential dataset from a data owner via a communication interface, the confidential dataset including a multi-dimensional privacy data that the data owner does not want to reveal when sharing data, and the confidential dataset being generated from an original distribution of dataset as released distribution dataset; defining a privacy metric as a probability of an attacker guessing the multi-dimensional privacy data by applying a first data processing algorithm onto the confidential dataset; defining a distortion metric of a data release mechanism as worst-case distance between the original distribution dataset and the released distribution dataset by applying a second data processing algorithm; and implementing the data release mechanism that minimizes the distortion metric subject to a constraint on the privacy metric for protecting the confidential aggregate dataset information when sharing data.

According to exemplary embodiments, the method may further include: implementing an algorithm for sharing data generated from a single-dimensional Gaussian distribution to preserve privacy and output the multi-dimensional privacy data. The privacy data may refer to “secrets” as disclosed herein.

According to exemplary embodiments, the method may further include: implementing an algorithm for sharing data generated from multi-dimensional Gaussian distribution with diagonal covariance matrix to preserve privacy and output the multi-dimensional privacy data.

According to exemplary embodiments, the method may further include: implementing an algorithm for sharing data generated from a two-dimensional Gaussian distribution to preserve privacy and output the multi-dimensional privacy data.

According to exemplary embodiments, the method may further include: defining a surrogate privacy metric based on calculating a difference between multi-dimensional privacy data of the original distribution dataset and the released distribution dataset to represent a privacy level.

According to exemplary embodiments, wherein smaller value corresponds to stronger privacy.

According to exemplary embodiments, the method may further include: defining a surrogate distortion metric as a distance between the original distribution dataset and the released distribution dataset by applying a third data processing algorithm.

According to exemplary embodiments, a system for protecting confidential aggregate dataset information when sharing data is disclosed. The system may include: a processor; and a memory operatively connected to the processor via a communication interface, the memory storing computer readable instructions, when executed, may cause the processor to: receive confidential dataset from a data owner via a communication interface, the confidential dataset including a multi-dimensional privacy data that the data owner does not want to reveal when sharing data, and the confidential dataset being generated from an original distribution of dataset as released distribution dataset; define a privacy metric as a probability of an attacker guessing the multi-dimensional privacy data by applying a first data processing algorithm onto the confidential dataset; define a distortion metric of a data release mechanism as worst-case distance between the original distribution dataset and the released distribution dataset by applying a second data processing algorithm; and implement the data release mechanism that minimizes the distortion metric subject to a constraint on the privacy metric for protecting the confidential aggregate dataset information when sharing data.

According to exemplary embodiments, the processor may be further configured to: implement an algorithm for sharing data generated from a single-dimensional Gaussian distribution to preserve privacy and output the multi-dimensional privacy data.

According to exemplary embodiments, the processor may be further configured to: implement an algorithm for sharing data generated from multi-dimensional Gaussian distribution with diagonal covariance matrix to preserve privacy and output the multi-dimensional privacy data.

According to exemplary embodiments, the processor may be further configured to: implement an algorithm for sharing data generated from a two-dimensional Gaussian distribution to preserve privacy and output the multi-dimensional privacy data.

According to exemplary embodiments, the processor may be further configured to: define a surrogate privacy metric based on calculating a difference between multi-dimensional privacy data of the original distribution dataset and the released distribution dataset to represent a privacy level.

According to exemplary embodiments, wherein smaller value corresponds to stronger privacy.

According to exemplary embodiments, the processor may be further configured to: define a surrogate distortion metric as a distance between the original distribution dataset and the released distribution dataset by applying a third data processing algorithm.

According to exemplary embodiments, a non-transitory computer readable medium configured to store instructions for protecting confidential aggregate dataset information when sharing data is disclosed. The instructions, when executed, may cause a processor to perform the following: receiving confidential dataset from a data owner via a communication interface, the confidential dataset including a multi-dimensional privacy data that the data owner does not want to reveal when sharing data, and the confidential dataset being generated from an original distribution of dataset as released distribution dataset; defining a privacy metric as a probability of an attacker guessing the multi-dimensional privacy data by applying a first data processing algorithm onto the confidential dataset; defining a distortion metric of a data release mechanism as worst-case distance between the original distribution dataset and the released distribution dataset by applying a second data processing algorithm; and implementing the data release mechanism that minimizes the distortion metric subject to a constraint on the privacy metric for protecting the confidential aggregate dataset information when sharing data.

According to exemplary embodiments, the instructions, when executed, may cause the processor to further perform the following: implementing an algorithm for sharing data generated from a single-dimensional Gaussian distribution to preserve privacy and output the multi-dimensional privacy data.

According to exemplary embodiments, the instructions, when executed, may cause the processor to further perform the following: implementing an algorithm for sharing data generated from multi-dimensional Gaussian distribution with diagonal covariance matrix to preserve privacy and output the multi-dimensional privacy data.

According to exemplary embodiments, the instructions, when executed, may cause the processor to further perform the following: implementing an algorithm for sharing data generated from a two-dimensional Gaussian distribution to preserve privacy and output the multi-dimensional privacy data.

According to exemplary embodiments, the instructions, when executed, may cause the processor to further perform the following: defining a surrogate privacy metric based on calculating a difference between multi-dimensional privacy data of the original distribution dataset and the released distribution dataset to represent a privacy level.

According to exemplary embodiments, wherein smaller value corresponds to stronger privacy.

According to exemplary embodiments, the instructions, when executed, may cause the processor to further perform the following: defining a surrogate distortion metric as a distance between the original distribution dataset and the released distribution dataset by applying a third data processing algorithm.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic data sharing module configured for analyzing the risks of compromising confidential dataset-level information when sharing data, and implementing “quantization-based” methods that provide provable privacy guarantees in accordance with an exemplary embodiment.

FIG. 2 illustrates an exemplary diagram of a network environment with a platform, language, database, and cloud agnostic data sharing device in accordance with an exemplary embodiment.

FIG. 3 illustrates a system diagram for implementing a platform, language, database, and cloud agnostic data sharing device having a platform, language, database, and cloud agnostic data sharing module in accordance with an exemplary embodiment.

FIG. 4 illustrates a system diagram for implementing a platform, language, database, and cloud agnostic data sharing module of FIG. 3 in accordance with an exemplary embodiment.

FIG. 5 illustrates an exemplary flow chart of a process implemented by the platform, language, database, and cloud agnostic data sharing module of FIG. 4 for analyzing the risks of compromising confidential dataset-level information when sharing data, and implementing “quantization-based” methods that provide provable privacy guarantees in accordance with an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

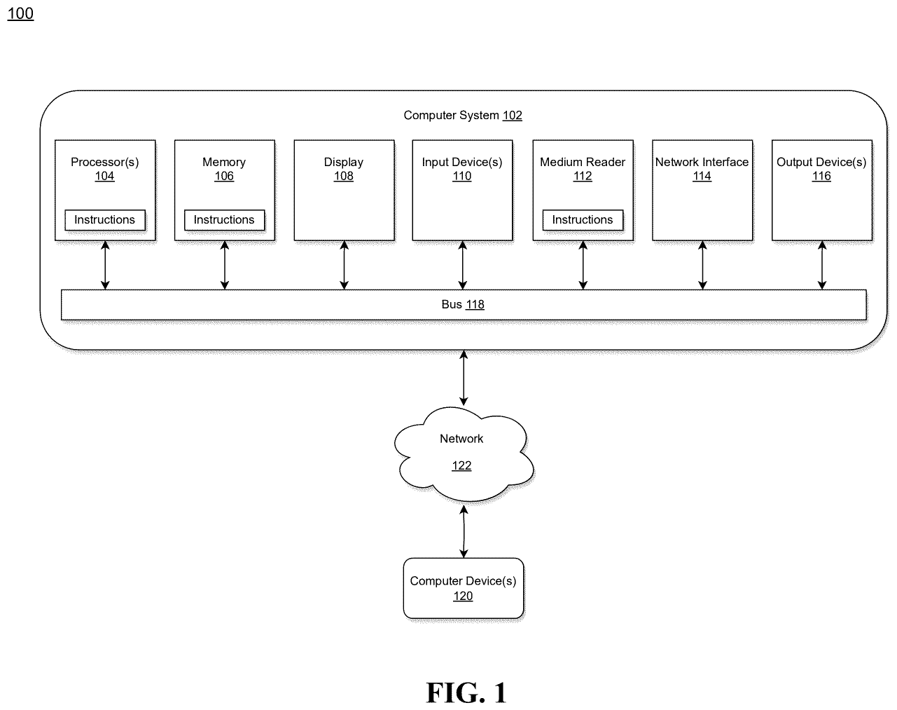

FIG. 1 is an exemplary system 100 for use in implementing a platform, language, database, and cloud agnostic data sharing module configured for analyzing the risks of compromising confidential dataset-level information when sharing data, and implementing “quantization-based” methods that provide provable privacy guarantees in accordance with an exemplary embodiment. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

According to exemplary embodiments, the data sharing module implemented by the system 100 may be platform, language, database, and cloud agnostic that may allow for consistent easy orchestration and passing of data through various components to output a desired result regardless of platform, browser, language, database, and cloud environment by writing programs accordingly. Since the disclosed process, according to exemplary embodiments, is platform, language, database, browser, and cloud agnostic, the data sharing module may be independently tuned or modified for optimal performance without affecting the configuration or data files. The configuration or data files, according to exemplary embodiments, may be written using JSON, but the disclosure is not limited thereto. For example, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

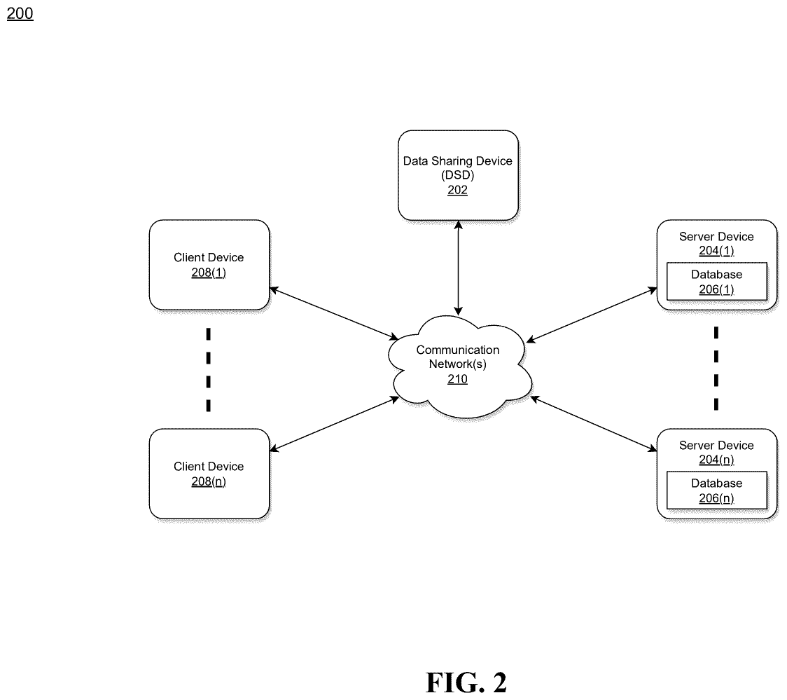

Referring to FIG. 2, a schematic of an exemplary network environment 200 for implementing a language, platform, database, and cloud agnostic data sharing device (DSD) of the instant disclosure is illustrated.

According to exemplary embodiments, the above-described problems associated with conventional tools may be overcome by implementing an DSD 202 as illustrated in FIG. 2 that may be configured for implementing a platform, language, database, and cloud agnostic data sharing module configured for analyzing the risks of compromising confidential dataset-level information when sharing data, and implementing “quantization-based” methods that provide provable privacy guarantees, but the disclosure is not limited thereto.

The DSD 202 may have one or more computer system 102s, as described with respect to FIG. 1, which in aggregate provide the necessary functions.

The DSD 202 may store one or more applications that can include executable instructions that, when executed by the DSD 202, cause the DSD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the DSD 202 itself, may be located in virtual server(s) running in a cloud-based computing environment rather than being tied to one or more specific physical network computing devices. Also, the application(s) may be running in one or more virtual machines (VMs) executing on the DSD 202. Additionally, in one or more embodiments of this technology, virtual machine(s) running on the DSD 202 may be managed or supervised by a hypervisor.

In the network environment 200 of FIG. 2, the DSD 202 is coupled to a plurality of server devices 204(1)-204(n) that hosts a plurality of databases 206(1)-206(n), and also to a plurality of client devices 208(1)-208(n) via communication network(s) 210. A communication interface of the DSD 202, such as the network interface 114 of the computer system 102 of FIG. 1, operatively couples and communicates between the DSD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the DSD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The DSD 202 may be a standalone device or integrated with one or more other devices or apparatuses, such as one or more of the server devices 204(1)-204(n), for example. In one particular example, the DSD 202 may be hosted by one of the server devices 204(1)-204(n), and other arrangements are also possible. Moreover, one or more of the devices of the DSD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the DSD 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the DSD 202 that may efficiently provide a platform for implementing a platform, language, database, and cloud agnostic data sharing module configured for analyzing the risks of compromising confidential dataset-level information when sharing data, and implementing “quantization-based”methods that provide provable privacy guarantees, but the disclosure is not limited thereto.

The client devices 208(1)-208(n) may run interface applications, such as standard web browsers or standalone client applications, which may provide an interface to communicate with the DSD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the DSD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the DSD 202, the server devices 204(1)-204(n), or the client devices 208(1)-208(n), for example, may be configured to operate as virtual instances on the same physical machine. For example, one or more of the DSD 202, the server devices 204(1)-204(n), or the client devices 208(1)-208(n) may operate on the same physical device rather than as separate devices communicating through communication network(s) 210. Additionally, there may be more or fewer DSDs 202, server devices 204(1)-204(n), or client devices 208(1)-208(n) than illustrated in FIG. 2. According to exemplary embodiments, the DSD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

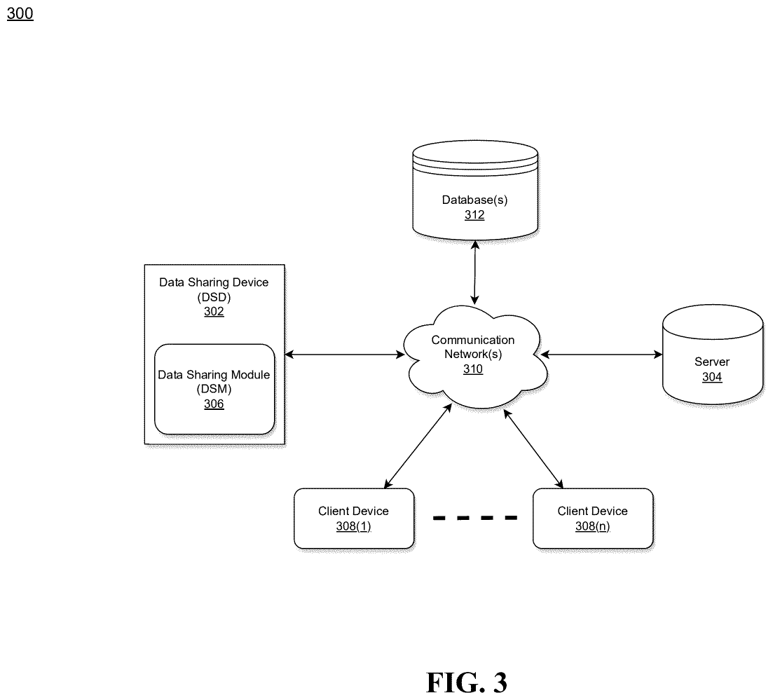

FIG. 3 illustrates a system diagram for implementing a platform, language, and cloud agnostic DSD having a platform, language, database, and cloud agnostic data sharing module (DSM) in accordance with an exemplary embodiment.

As illustrated in FIG. 3, the system 300 may include an DSD 302 within which an DSM 306 is embedded, a server 304, a database(s) 312, a plurality of client devices 308(1) . . . 308(n), and a communication network 310.

According to exemplary embodiments, the DSD 302 including the DSM 306 may be connected to the server 304, and the database(s) 312 via the communication network 310. The DSD 302 may also be connected to the plurality of client devices 308(1) . . . 308(n) via the communication network 310, but the disclosure is not limited thereto. The database(s) 312 may include rule database.

According to exemplary embodiment, the DSD 302 is described and shown in FIG. 3 as including the DSM 306, although it may include other rules, policies, modules, databases, or applications, for example. According to exemplary embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

According to exemplary embodiments, the DSM 306 may be configured to receive real-time feed of data from the plurality of client devices 308(1) . . . 308(n) and secondary sources via the communication network 310.

As may be described below, the DSM 306 may be configured to: receive confidential dataset from a data owner via a communication interface, the confidential dataset including a multi-dimensional privacy data that the data owner does not want to reveal when sharing data, and the confidential dataset being generated from an original distribution of dataset as released distribution dataset; define a privacy metric as a probability of an attacker guessing the multi-dimensional privacy data by applying a first data processing algorithm onto the confidential dataset; define a distortion metric of a data release mechanism as worst-case distance between the original distribution dataset and the released distribution dataset by applying a second data processing algorithm; and implement the data release mechanism that minimizes the distortion metric subject to a constraint on the privacy metric for protecting the confidential aggregate dataset information when sharing data, but the disclosure is not limited thereto.

The plurality of client devices 308(1) . . . 308(n) are illustrated as being in communication with the DSD 302. In this regard, the plurality of client devices 308(1) . . . 308(n) may be “clients” (e.g., customers) of the DSD 302 and are described herein as such. Nevertheless, it is to be known and understood that the plurality of client devices 308(1) . . . 308(n) need not necessarily be “clients” of the DSD 302, or any entity described in association therewith herein. Any additional or alternative relationship may exist between either or both of the plurality of client devices 308(1) . . . 308(n) and the DSD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the DSD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The DSD 302 may be the same or similar to the DSD 202 as described with respect to FIG. 2, including any features or combination of features described with respect thereto.

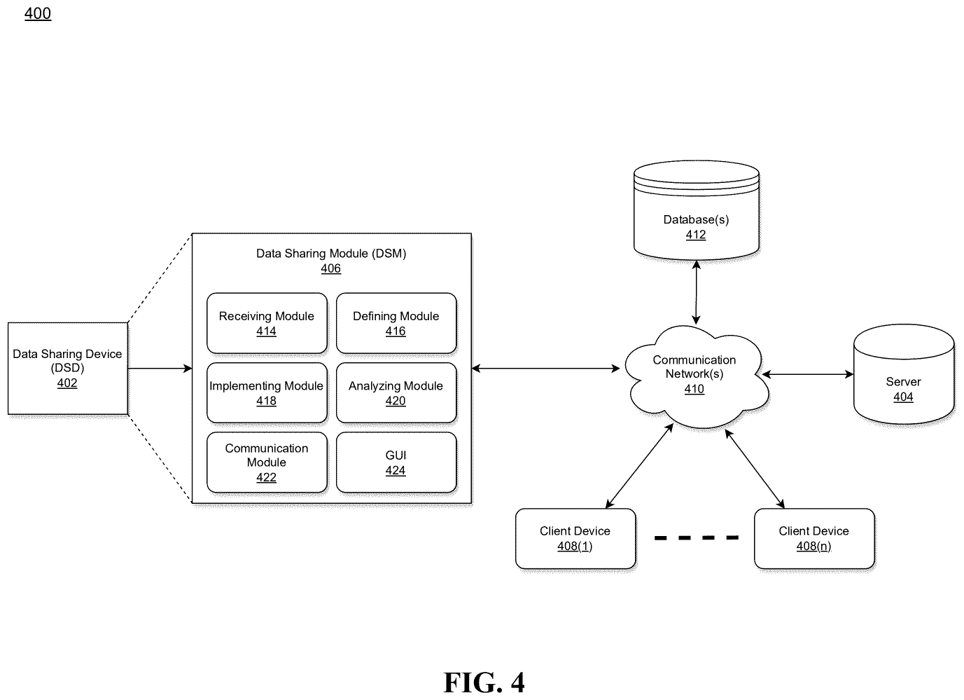

FIG. 4 illustrates a system diagram for implementing a platform, language, database, and cloud agnostic DSM of FIG. 3 in accordance with an exemplary embodiment.

According to exemplary embodiments, the system 400 may include a platform, language, database, and cloud agnostic DSD 402 within which a platform, language, database, and cloud agnostic DSM 406 is embedded, a server 404, database(s) 412, and a communication network 410. According to exemplary embodiments, server 404 may comprise a plurality of servers located centrally or located in different locations, but the disclosure is not limited thereto.

According to exemplary embodiments, the DSD 402 including the DSM 406 may be connected to the server 404, and the database(s) 412 via the communication network 410. The DSD 402 may also be connected to the plurality of client devices 408(1)-408(n) via the communication network 410, but the disclosure is not limited thereto. The DSM 406, the server 404, the plurality of client devices 408(1)-408(n), the database(s) 412, the communication network 410 as illustrated in FIG. 4 may be the same or similar to the DSM 306, the server 304, the plurality of client devices 308(1)-308(n), the database(s) 312, the communication network 310, respectively, as illustrated in FIG. 3.

According to exemplary embodiments, the DSM 406 may be configured to implement the generative model 405 that analyzes the risks of compromising confidential dataset-level information when sharing data, and implementing “quantization-based” methods that provide provable privacy guarantees, thereby protecting confidential aggregate dataset information when sharing data, but the disclosure is not limited thereto.

Details of the DSM 406 is provided below with corresponding modules that may be configured to, in combination, results in analyzing the risks of compromising confidential dataset-level information when sharing data, and implementing “quantization-based” methods that provide provable privacy guarantees, thereby protecting confidential aggregate dataset information when sharing data, as illustrated in FIGS. 4-6.

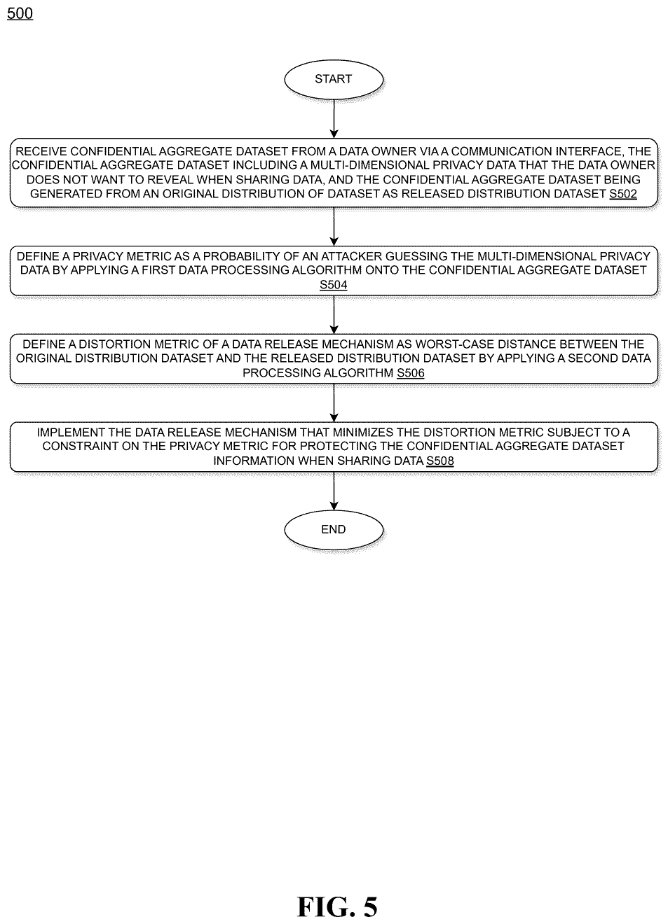

According to exemplary embodiments, as illustrated in FIG. 4, the DSM 406 may include a receiving module 414, a defining module 416, an implementing module 418, an analyzing module 420, a communication module 422, and a GUI 424. According to exemplary embodiments, interactions and data exchange among these modules included in the DSM 406 provide the advantageous effects of the disclosed invention. Functionalities of each module of FIG. 4 may be described in detail below with reference to FIGS. 5-6.

According to exemplary embodiments, each of the receiving module 414, defining module 416, implementing module 418, analyzing module 420, and the communication module 422 of the DSM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the receiving module 414, defining module 416, implementing module 418, analyzing module 420, and the communication module 422 of the DSM 406 of FIG. 4 may be implemented by microprocessors or similar, and may be programmed using software (e.g., microcode) to perform various functions discussed herein and may optionally be driven by firmware and/or software.

Alternatively, according to exemplary embodiments, each of the receiving module 414, defining module 416, implementing module 418, analyzing module 420, and the communication module 422 of the DSM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. For example, the DSM 406 of FIG. 4 may also be implemented by Cloud based deployment.

According to exemplary embodiments, each of the implementing module 414, training module 416, receiving module 418, perturbing module 420, executing module 422, deriving module 424, estimating module 426, and the communication module 428 of the DSM 406 of FIG. 4 may be called via corresponding API, but the disclosure is not limited thereto.

According to exemplary embodiments, the process implemented by the DSM 406 may be executed via the communication module 422 and the communication network 410, which may comprise plural networks as described above. For example, in an exemplary embodiment, the various components of the DSM 406 may communicate with the server 404, and the database(s) 412 via the communication module 422 and the communication network 410 and the results (i.e., probability value; empirical estimate, etc.) may be displayed onto the GUI 424. Of course, these embodiments are merely exemplary and are not limiting or exhaustive. The database(s) 412 may include the databases included within the private cloud and/or public cloud and the server 404 may include one or more servers within the private cloud and the public cloud.

According to exemplary embodiments, the receiving module 414 may be configured to receive confidential dataset from a data owner via a communication interface included within the communication module 422, the confidential dataset including a multi-dimensional privacy data that the data owner does not want to reveal when sharing data, and the confidential dataset being generated from an original distribution of dataset as released distribution dataset.

According to exemplary embodiments, the defining module 416 may be configured to define a privacy metric as a probability of an attacker guessing the multi-dimensional privacy data by applying a first data processing algorithm onto the confidential dataset; define a distortion metric of a data release mechanism as worst-case distance between the original distribution dataset and the released distribution dataset by applying a second data processing algorithm.

According to exemplary embodiments, the implementing module 418 may be configured to implement the data release mechanism that minimizes the distortion metric subject to a constraint on the privacy metric for protecting the confidential aggregate dataset information when sharing data.

According to exemplary embodiments, the analyzing module 420 may be further configured to implement an algorithm for sharing data generated from a single-dimensional Gaussian distribution to preserve privacy and output the multi-dimensional privacy data.

According to exemplary embodiments, the analyzing module 420 may be further configured to implement an algorithm for sharing data generated from multi-dimensional Gaussian distribution with diagonal covariance matrix to preserve privacy and output the multi-dimensional privacy data.

According to exemplary embodiments, the analyzing module 420 may be further configured to implement an algorithm for sharing data generated from a two-dimensional Gaussian distribution to preserve privacy and output the multi-dimensional privacy data.

According to exemplary embodiments, the defining module 416 may be further configured to define a surrogate privacy metric based on calculating a difference between multi-dimensional privacy data of the original distribution dataset and the released distribution dataset to represent a privacy level.

According to exemplary embodiments, wherein smaller value corresponds to stronger privacy.

According to exemplary embodiments, the defining module 416 may be further configured to define a surrogate distortion metric as a distance between the original distribution dataset and the released distribution dataset by applying a third data processing algorithm.

For example, for metric design, different from the single secret privacy framework, the DSM 406 may be configured to determine a new metric to measure the privacy level of the shared data. Since there are multiple secrets (i.e., privacy data as referred herein), the DSM 406 may be configured to have several different ways to define the privacy level of data owner protecting multiple secrets simultaneously. As disclosed herein, the DSM 406 may be configured to consider the worst case, and define the privacy metric as attacker successfully guessing at least one secret correctly with a certain tolerance range. This may be the strictest metric for the data holder, and it applies to the scenario where the data holder does not want to reveal any of the business secret. As for the distortion metric, the DSM 406 may be configured to measure the utility if the released dataset by using the worst case distributional distance between the original and the released dataset. In the data holders' point of view, they want to maximize the data utility of the released data while satisfying certain level of the summary statistics privacy.

According to exemplary embodiments, for privacy-distortion tradeoffs, the general lower bound of the distortion given a certain budget of the privacy is provided. The analysis of the lower bound is general, but the value of the bound depends on data distributions and the secrets. The bound also reveals how the number of secrets affect the privacy-distortion tradeoffs. The DSM 406 may be configured to then specify the value of the distortion lower bound under several specific distributions. Based on the lower bound, the DSM 406 may be configured to also analyze whether our designed mechanisms could achieve optimal or order optimal privacy-distortion tradeoffs.

According to exemplary embodiments, for mechanism design. Under different data distributions and secret types, the DSM 406 may be configured to design the data release mechanisms and analyze the performance of them. Intuitively, those mechanisms quantize the parameters of the distributions into bins, and then output the midpoints of the bins that the parameters fall into. Those mechanisms are easy to understand and implement.

For empirical evaluation, the DSM 406 may be configured to adopt real world dataset to implement the data release mechanisms for the DSM 406 to design and illustrate the privacy-distortion tradeoff of the released dataset based on the proposed surrogated privacy and distortion metrics.

### Metrics for Preserving Multi-Dimensional Secrets

The DSM 406 may define the privacy and distortion metrics as follows.

For privacy metric, the DSM 406 may be configured to define a privacy metric Π_{∈,ω}_{_{Θ}} as the probability of attacker guessing the d-dimension secrets to within a tolerance Ei for each dimension i∈[d], taken the best attacker strategy g:

$${Π}_{ϵ , {ω}_{Θ}} {=}^{△} {sup}_{\hat{g}} ℙ ( {⋃}_{i ∈ [ d ]} \vert {\hat{g}}_{i} ( {θ}^{′} ) - {g}_{i} ( θ ) \vert \leq {ϵ}_{i} ) \qquad ( 1 )$$

For distortion metric, the DSM 406 may be configured to define the distortion Δ of a mechanism as the worst-case distance between the original distribution and the released distribution:

$$△ {=}^{△} {{sup}_{θ ϵ Supp ( {ω}_{Θ} ) , {θ}^{′}}}_{z ∈ Supp ( {ω}_{z} ) : {ℳ}_{g} ( θ , z ) = {θ}^{′}} d ( {ω}_{{x}_{θ}} ‖ {ω}_{{x}_{{θ}^{′}}} ) , \qquad ( 2 )$$

where dis a general distance metric defined over distributions.

The data holder's objective is to choose a data release mechanism that minimizes distortion metric A subject to a constraint on privacy Π_{∈,ω}_{_{Θ}}:

$$\begin{matrix}{min}_{{ℳ}_{g}} & △ \\ subject to & {Π}_{ϵ , {ω}_{Θ}} \leq T\end{matrix} \qquad ( 3 )$$

Given a privacy budget T, the DSM 406 may be configured to first present a lower bound on distortion that applies regardless of the prior distribution of data oo and regardless of the secret g. The DSM 406 may be configured to assume that the secret is in d dimension, and the data distribution can have arbitrary dimension.

(Lower bound of privacy-distortion tradeoff). Let

$$D ( {X}_{{θ}_{1}} , {X}_{{θ}_{2}} ) {=}^{Δ} \frac{1}{2} d ( {ω}_{{X}_{{θ}_{1}}} ‖ {ω}_{{X}_{{θ}_{2}}} ) .$$

Further, let R(X_{θ}_{₁}, X_{θ}_{₂})≙Π_{i∈[d]}|gᵢ(θ₁)−gᵢ(θ₂)|^{1/d} and

$$γ {=}^{Δ} {inf}_{{θ}_{1} , {θ}_{2} ∈ Supp ( {ω}_{Θ} )} \frac{D ( {X}_{{θ}_{1}} , {X}_{{θ}_{2}} )}{R ( {X}_{{θ}_{1}} , {X}_{{θ}_{2}} )} \qquad ( 4 )$$

For any T∈(0,1), when Π_{∈,ω}_{_{Θ}},

$$Δ > 2 γ \cdot ⌈ \frac{1}{1 - {( 1 - T )}^{\frac{1}{d}}} - 1 ⌉ \cdot {( {\prod }_{i ∈ [ d ]} {ϵ}_{i} )}^{\frac{1}{d}} \qquad ( 5 )$$

According to exemplary embodiments, the DSM 406 may be configured to mainly focus on Gaussian distributions with multi-dimensional secrets. The DSM 406 may be configured to first analyze the single-dimensional Gaussian distribution with mean and standard deviation as the secrets, and then focus on multi-dimensional Gaussian with diagonal covariance matrix. Finally, the DSM 406 may be configured to focus on general multi-dimensional Gaussian distribution. As disclosed herein, the DSM 406 may be configured to select Wasserstein-1 distance as the distance meter d.

When secrets are mean and std, and distribution is 1-dimensional Gaussian, the value of γ defined in Eq. (4) is shown in Proposition below.

Proposition 1. When secrets are mean and std, and distribution is 1-dimensional Gaussian, the privacy-distortion tradeoff constant γ is

$$γ = \frac{\sqrt{2}}{2}$$

Then the data release mechanism may be provided as follows.

Mechanism 1. For each parameter, μ and σ, quantize it into several bins, whose size is s_{μ} and s_{σ} respectively. If the original parameter value p falls into the i-th bin and σ falls into the j-th bin, i.e., μ∈[μ+i·s_{μ}, μ+(i+1)·s_{μ}) and σ∈[σ+j·s_{σ}, σ+(j+1)·s_{σ}), then output

$$( {μ}^{′} , {σ}^{′} ) + ( \underline{μ} + ( 1 + \frac{1}{2} ) \cdot {s}_{μ} , σ + ( j + \frac{1}{2} ) \cdot {s}_{σ} .$$

The pseudo code of Mech. 1 is shown in Algorithm 1.

Algorithm 1: Data release mechanism for 1-dimensional Gaussian Input: θ=(μ, σ), lower bound μ of μ, lower bound σ of σ, quantization interval s_{μ}, s_{σ}
1.

$${μ}^{′} ← \underline{μ} + ( ⌊ \frac{μ - \underline{μ}}{{s}_{μ}} ⌋ + 0.5 ) \cdot {s}_{μ}$$

2.

$${σ}^{′} ← \underline{σ} + ( ⌊ \frac{σ - \underline{σ}}{{s}_{σ}} ⌋ + 0.5 ) \cdot {s}_{σ}$$

3. Output Gaussian distribution with θ′ (μ′, σ′).

When Secrets={mean, std}^{d}, distribution=multi-dimensional Gaussian with Diagonal covariance matrix, the DSM 406 may be configured to focus on k-dimensional Gaussian distribution with diagonal covariance matrix, i.e., θ=(μ₁, . . . μₖ, σ₁, . . . , σₖ). The DSM 406 may be configured to consider d-dimensional secrets, where d≤2k, with each secret can be either mean or standard deviation of any dimension of the distribution, i.e., gᵢ(θ)∈{μ₁, . . . μₖ, σ₁, . . . , σₖ}∀ᵢ∈[d].

Lemma. D(X_{θ}, X_{θ},) can be derived as:

$$D ( {X}_{θ} , {X}_{{θ}^{′}} ) = \frac{1}{2} \sqrt{{\sum }_{j ∈ [ k ]} {( {μ}_{j} - {μ}_{j}^{′} )}^{2} + {\sum }_{j ∈ [ k ]} {( {σ}_{j} - {σ}_{j}^{′} )}^{2}}$$

Based on Lemma, the DSM 406 may be configured to analyze the privacy-distortion tradeoff constant γ as follows.

Proposition 2. Suppose distribution is k-dimensional Gaussian distribution with diagonal covariance matrix, and secrets are in d dimensional and each secret can be either mean or standard deviation of any dimension of the distribution. In this case, the privacy-distortion tradeoff constant γ is

$$γ = \frac{\sqrt{d}}{2}$$

and the data release mechanism may be provided as follows.

Mechanism 2. For each parameter μⱼ and σₗ where μⱼ, σₗ∈{gᵢ(θ)}_{i∈[d]}, quantize it into several bins, whose size is s_{μ}_{ⱼ} and s_{σ}_{ₗ} respectively. If the original parameter value μⱼ falls into the αⱼ-th bin and σₗ falls into the bₗ-th bin, i.e., μⱼ∈[μⱼ+αⱼ·s_{μ}_{ⱼ}+(αⱼ+1)·s_{μ}_{ⱼ}) and σₗ∈[σₗ+bₗ·s_{σ}_{ₗ}, σₗ+(bₗ+1)·s_{σl}), then output

$${μ}_{j}^{′} as \underline{{μ}_{j}} + ( {a}_{j} + \frac{1}{2} ) \cdot {s}_{{μ}_{j}} and {σ}_{j}^{′} as \underline{{σ}_{l}} + ( {b}_{l} + \frac{1}{2} ) \cdot {s}_{{σ}_{l}} .$$

The pseudo code of mechanism 2 is shown in algorithm 2 below.

Algorithm 2: Data release mechanism for multi-dimensional Gaussian with Diagonal covariance matrix.

Input: θ=(μ₁, . . . μₖ, σ₁, . . . , σₖ), lower bound gᵢ(θ) of secret gᵢ(θ), quantization interval s_{g}_{ᵢ}_{(θ)}, ∀ᵢ∈[d].

1.

$${g}_{i}^{′} ( θ ) ← \underline{{g}_{i} ( θ )} + ( ⌊ \frac{{g}_{i} ( θ ) - \underline{{g}_{i} ( θ )}}{{s}_{{g}_{i} ( θ )}} ⌋ + 0.5 ) \cdot {s}_{{g}_{i} ( θ )}$$

2. Output Gaussian distribution with secret parameter as g′ᵢ(θ) and non-secret parameter as the original value.
When Secrets={mean, std}^{d}, distribution=2-dimensional Gaussian, the DSM 406 may be configured to focus on 2-dimensional Gaussian distribution, i.e., N(μ, Σ), where μ=[u₁, u₂], and

$$\sum = [ \begin{matrix}{σ}_{1}^{2} & {σ}_{12} \\ {σ}_{21} & {σ}_{2}^{2}\end{matrix} ] = [ \begin{matrix}cos α & - sin α \\ sin α & cos α\end{matrix} ] [ \begin{matrix}{λ}_{1} & 0 \\ 0 & {λ}_{2}\end{matrix} ] [ \begin{matrix}cos α & sin α \\ - sin α & cos α\end{matrix} ]$$

where α∈[0, π). the DSM 406 may be configured to can see that the 2-dimensional Gaussian distribution is determined by five independent parameters θ=(μ₁, μ₂, λ₁, Δ₂, α).

Here, the DSM 406 may be configured to use independent parameters (μ₁, μ₂, Δ₁, Δ₂, α) because the attacker cannot infer the value of a parameter based on any other parameters. However, if the DSM 406 uses the parameter (μ₁, μ₂, σ₁, σ₂, σ₁₂), since they satisfy σ₁σ₂≥σ₁₂, the attacker may use this dependency to infer the value of a parameter.

One may consider d-dimensional secrets, where d≤4, with each secret can be either mean or standard deviation of any dimension of the distribution, i.e., gᵢ(θ)∈{μ₁, μ₂, σ₁, σ₂}, ∀ᵢ∈[d].

Let θ=(μ′₁, μ′₂, λ′₁, λ′₂, α′). From [1], the DSM 406 may be configured to have

$${d ( {ω}_{{X}_{θ}} ‖ {ω}_{{X}_{{θ}^{′}}} )}^{2} = {( {μ}_{1} - {μ}_{1}^{′} )}^{2} + {( {μ}_{2} - {μ}_{2}^{′} )}^{2} + Tr ( \sum + {\sum }^{′} - 2 {( {\sum }^{\frac{1}{2}} {\sum }^{′} {\sum }^{\frac{1}{2}} )}^{\frac{1}{2}} )$$

### EXPERIMENTS

### Metrics

The privacy and distortion metrics require the knowledge of prior distribution of original data distribution parameters θ˜ω_{θ}, which cannot be obtained in practice since the data holder can only have one dataset. Therefore, the DSM 406 may be configured to design the surrogate privacy and distortion metrics to bound the real privacy and distortion values in experiments.

Surrogate privacy metric—For the original dataset X and the released dataset Y, the DSM 406 may be configured to define the surrogate privacy metric as

$${\tilde{Π}}_{ϵ , {ω}_{θ}} = {max}_{i ∈ [ d ]} \{ - \vert {g}_{i} ( X ) - {g}_{i} ( Y ) \vert / {ϵ}_{i} \}$$

where gᵢ(D) is the i-th secret of the dataset D, and ∈ᵢ is the tolerance range of the i-th secret. the DSM 406 may be configured to use the difference between the secrets of original and released datasets to represent the privacy level, and use the negative sign to ensure that smaller value means stronger privacy. Since the tolerance ranges of different secrets are not the same, the put ∈ᵢ to the denominator to normalize the difference. When the prior distribution ω_{Θ} is uniform, guessing the i-th secret as gᵢ(Y) is the optimal attack strategy, and therefore there is a mapping between Π_{∈,ω}_{_{Θ}} and \tilde{Π}_{∈,ω}_{_{Θ}}. Hence, the surrogate is a proper approximate of Π_{∈,ω}_{_{Θ}}.

Surrogate distortion metric—the DSM 406 may be configured to define the surrogate distortion metric as the distance between the original and the released dataset:

$$\tilde{Δ} = d ( {P}_{X} ‖ {P}_{Y} )$$

where P_{D} is the empirical distribution of the dataset D, and d is defined in the line under Eq. (2).

FIG. 5 illustrates an exemplary flow chart of a process 500 implemented by the platform, language, database, and cloud agnostic DSM 406 of FIG. 4 for analyzing the risks of compromising confidential dataset-level information when sharing data, and implementing “quantization-based” methods that provide provable privacy guarantees in accordance with an exemplary embodiment. It may be appreciated that the illustrated process 500 and associated steps may be performed in a different order, with illustrated steps omitted, with additional steps added, or with a combination of reordered, combined, omitted, or additional steps.

As illustrated in FIG. 5, at step S502, the process 500 may include receiving confidential dataset from a data owner via a communication interface, the confidential dataset including a multi-dimensional privacy data that the data owner does not want to reveal when sharing data, and the confidential dataset being generated from an original distribution of dataset as released distribution dataset.

At step S504, the process 500 may include defining a privacy metric as a probability of an attacker guessing the multi-dimensional privacy data by applying a first data processing algorithm onto the confidential dataset.

At step S506, the process 500 may include defining a distortion metric of a data release mechanism as worst-case distance between the original distribution dataset and the released distribution dataset by applying a second data processing algorithm.

At step S508, the process 500 may include implementing the data release mechanism that minimizes the distortion metric subject to a constraint on the privacy metric for protecting the confidential aggregate dataset information when sharing data.

According to exemplary embodiments, the process 500 may further include: implementing an algorithm for sharing data generated from a single-dimensional Gaussian distribution to preserve privacy and output the multi-dimensional privacy data.

According to exemplary embodiments, the process 500 may further include: implementing an algorithm for sharing data generated from multi-dimensional Gaussian distribution with diagonal covariance matrix to preserve privacy and output the multi-dimensional privacy data.

According to exemplary embodiments, the process 500 may further include: implementing an algorithm for sharing data generated from a two-dimensional Gaussian distribution to preserve privacy and output the multi-dimensional privacy data.

According to exemplary embodiments, the process 500 may further include: defining a surrogate privacy metric based on calculating a difference between multi-dimensional privacy data of the original distribution dataset and the released distribution dataset to represent a privacy level.

According to exemplary embodiments, in the process 500, smaller value corresponds to stronger privacy.

According to exemplary embodiments, the process 500 may further include: defining a surrogate distortion metric as a distance between the original distribution dataset and the released distribution dataset by applying a third data processing algorithm.

According to exemplary embodiments, the DSD 402 may include a memory (e.g., a memory 106 as illustrated in FIG. 1) which may be a non-transitory computer readable medium that may be configured to store instructions for protecting confidential aggregate dataset information when sharing data as disclosed herein. The DSD 402 may also include a medium reader (e.g., a medium reader 112 as illustrated in FIG. 1) which may be configured to read any one or more sets of instructions, e.g., software, from any of the memories described herein. The instructions, when executed by a processor embedded within the DSM 406 or within the DSD 402, may be used to perform one or more of the methods and processes as described herein. In a particular embodiment, the instructions may reside completely, or at least partially, within the memory 106, the medium reader 112, and/or the processor 104 (see FIG. 1) during execution by the DSD 402.

According to exemplary embodiments, the instructions, when executed, may cause a processor embedded within the DSM 406 or the DSD 402 to perform the following: receiving confidential dataset from a data owner via a communication interface, the confidential dataset including a multi-dimensional privacy data that the data owner does not want to reveal when sharing data, and the confidential dataset being generated from an original distribution of dataset as released distribution dataset; defining a privacy metric as a probability of an attacker guessing the multi-dimensional privacy data by applying a first data processing algorithm onto the confidential dataset; defining a distortion metric of a data release mechanism as worst-case distance between the original distribution dataset and the released distribution dataset by applying a second data processing algorithm; and implementing the data release mechanism that minimizes the distortion metric subject to a constraint on the privacy metric for protecting the confidential aggregate dataset information when sharing data. According to exemplary embodiments, the processor may be the same or similar to the processor 104 as illustrated in FIG. 1 or the processor embedded within the DSD 202, DSD 302, DSD 402, and DSM 406 which is the same or similar to the processor 104.

According to exemplary embodiments, the instructions, when executed, may cause the processor 104 to further perform the following: implementing an algorithm for sharing data generated from a single-dimensional Gaussian distribution to preserve privacy and output the multi-dimensional privacy data.

According to exemplary embodiments, the instructions, when executed, may cause the processor 104 to further perform the following: implementing an algorithm for sharing data generated from multi-dimensional Gaussian distribution with diagonal covariance matrix to preserve privacy and output the multi-dimensional privacy data.

According to exemplary embodiments, the instructions, when executed, may cause the processor 104 to further perform the following: implementing an algorithm for sharing data generated from a two-dimensional Gaussian distribution to preserve privacy and output the multi-dimensional privacy data.

According to exemplary embodiments, the instructions, when executed, may cause the processor 104 to further perform the following: defining a surrogate privacy metric based on calculating a difference between multi-dimensional privacy data of the original distribution dataset and the released distribution dataset to represent a privacy level.

According to exemplary embodiments, wherein smaller value corresponds to stronger privacy.

According to exemplary embodiments, the instructions, when executed, may cause the processor 104 to further perform the following: defining a surrogate distortion metric as a distance between the original distribution dataset and the released distribution dataset by applying a third data processing algorithm.

According to exemplary embodiments as disclosed above in FIGS. 1-5, technical improvements effected by the instant disclosure may include a platform for implementing a platform, language, database, and cloud agnostic data sharing module configured for analyzing the risks of compromising confidential dataset-level information when sharing data, and implementing “quantization-based” methods that provide provable privacy guarantees, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for protecting confidential aggregate dataset information when sharing data by utilizing one or more processors along with allocated memory, the method comprising:
receiving confidential dataset from a data owner via a communication interface, the confidential dataset including a multi-dimensional privacy data that the data owner does not want to reveal when sharing data, and the confidential dataset being generated from an original distribution of dataset as released distribution dataset;
defining a privacy metric as a probability of an attacker guessing the multi-dimensional privacy data by applying a first data processing algorithm onto the confidential dataset;
defining a distortion metric of a data release mechanism as worst-case distance between the original distribution dataset and the released distribution dataset by applying a second data processing algorithm; and
implementing the data release mechanism that minimizes the distortion metric subject to a constraint on the privacy metric for protecting the confidential aggregate dataset information when sharing data.

2. The method according to claim 1, further comprising:
implementing an algorithm for sharing data generated from a single-dimensional Gaussian distribution to preserve privacy and output the multi-dimensional privacy data.

3. The method according to claim 2, further comprising:
implementing an algorithm for sharing data generated from multi-dimensional Gaussian distribution with diagonal covariance matrix to preserve privacy and output the multi-dimensional privacy data.

4. The method according to claim 3, further comprising:
implementing an algorithm for sharing data generated from a two-dimensional Gaussian distribution to preserve privacy and output the multi-dimensional privacy data.

5. The method according to claim 1, further comprising:
defining a surrogate privacy metric based on calculating a difference between multi-dimensional privacy data of the original distribution dataset and the released distribution dataset to represent a privacy level.

6. The method according to claim 5, wherein smaller value corresponds to stronger privacy.

7. The method according to claim 1, further comprising:
defining a surrogate distortion metric as a distance between the original distribution dataset and the released distribution dataset by applying a third data processing algorithm.

8. A system for protecting confidential aggregate dataset information when sharing data, the system comprising:
a processor; and
a memory operatively connected to the processor via a communication interface, the memory storing computer readable instructions, when executed, causes the processor to:
receive confidential dataset from a data owner via a communication interface, the confidential dataset including a multi-dimensional privacy data that the data owner does not want to reveal when sharing data, and the confidential dataset being generated from an original distribution of dataset as released distribution dataset;
define a privacy metric as a probability of an attacker guessing the multi-dimensional privacy data by applying a first data processing algorithm onto the confidential dataset;
define a distortion metric of a data release mechanism as worst-case distance between the original distribution dataset and the released distribution dataset by applying a second data processing algorithm; and
implement the data release mechanism that minimizes the distortion metric subject to a constraint on the privacy metric for protecting the confidential aggregate dataset information when sharing data.

9. The system according to claim 8, wherein the processor is further configured to:
implement an algorithm for sharing data generated from a single-dimensional Gaussian distribution to preserve privacy and output the multi-dimensional privacy data.

10. The system according to claim 9, wherein the processor is further configured to:
implement an algorithm for sharing data generated from multi-dimensional Gaussian distribution with diagonal covariance matrix to preserve privacy and output the multi-dimensional privacy data.

11. The system according to claim 10, wherein the processor is further configured to:
implement an algorithm for sharing data generated from a two-dimensional Gaussian distribution to preserve privacy and output the multi-dimensional privacy data.

12. The system according to claim 8, wherein the processor is further configured to:
define a surrogate privacy metric based on calculating a difference between multi-dimensional privacy data of the original distribution dataset and the released distribution dataset to represent a privacy level.

13. The system according to claim 12, wherein smaller value corresponds to stronger privacy.

14. The system according to claim 8, wherein the processor is further configured to:
define a surrogate distortion metric as a distance between the original distribution dataset and the released distribution dataset by applying a third data processing algorithm.

15. A non-transitory computer readable medium configured to store instructions for protecting confidential aggregate dataset information when sharing data, the instructions, when executed, cause a processor to perform the following:
receiving confidential dataset from a data owner via a communication interface, the confidential dataset including a multi-dimensional privacy data that the data owner does not want to reveal when sharing data, and the confidential dataset being generated from an original distribution of dataset as released distribution dataset;
defining a privacy metric as a probability of an attacker guessing the multi-dimensional privacy data by applying a first data processing algorithm onto the confidential dataset;
defining a distortion metric of a data release mechanism as worst-case distance between the original distribution dataset and the released distribution dataset by applying a second data processing algorithm; and
implementing the data release mechanism that minimizes the distortion metric subject to a constraint on the privacy metric for protecting the confidential aggregate dataset information when sharing data.

16. The method according to claim 15, wherein the instructions, when executed, cause the processor to further perform the following:
implementing an algorithm for sharing data generated from a single-dimensional Gaussian distribution to preserve privacy and output the multi-dimensional privacy data.

17. The method according to claim 16, wherein the instructions, when executed, cause the processor to further perform the following:
implementing an algorithm for sharing data generated from multi-dimensional Gaussian distribution with diagonal covariance matrix to preserve privacy and output the multi-dimensional privacy data.

18. The method according to claim 17, wherein the instructions, when executed, cause the processor to further perform the following:
implementing an algorithm for sharing data generated from a two-dimensional Gaussian distribution to preserve privacy and output the multi-dimensional privacy data.

19. The method according to claim 15, wherein the instructions, when executed, cause the processor to further perform the following:
defining a surrogate privacy metric based on calculating a difference between multi-dimensional privacy data of the original distribution dataset and the released distribution dataset to represent a privacy level.

20. The method according to claim 19, wherein the instructions, when executed, cause the processor to further perform the following:
defining a surrogate distortion metric as a distance between the original distribution dataset and the released distribution dataset by applying a third data processing algorithm.
